(19) United States
(12) Patent Application Publication
(10) Pub. No.: US 2021/0357210 A1
(43) Pub. Date: Nov. 18, 2021

(54) AUTOMATIC GENERATION OF CODE DOCUMENTATION

(71) Applicant: MICROSOFT TECHNOLOGY LICENSING, LLC., REDMOND, WA (US)

(72) Inventors: COLIN BRUCE CLEMENT, SEATTLE, WA (US); JAMES DRAIN, BELLEVUE, WA (US); NEELAKANTAN SUNDARESAN, BELLEVUE, WA (US); ALEXEY SVYATKOVSKIY, BELLEVUE, WA (US)

(21) Appl. No.: 16/897,813

(22) Filed: Jun. 10, 2020

Related U.S. Application Data
(60) Provisional application No. 63/025,544, filed on May 15, 2020.

(51) Int. Cl. G06F 8/73; G06F 8/60; G06N 3/04; G06N 3/08

(52) U.S. Cl. CPC G06F 8/73; G06N 3/088; G06N 3/0454; G06F 8/60

(57) ABSTRACT

A code completion tool uses a neural transformer model with attention to generate code documentation for a method in a particular code documentation style. The neural transformer model is trained with source code programs and natural language text. The neural transformer model is pre-trained to learn the meaning of a method name, its corresponding method parameters and types from a large corpus of unsupervised dataset of source code methods. The neural transformer model is then fine-tuned on translation tasks where the model leans to translate a method signature/method body into a docstring of particular code documentation style.

### CROSS-REFERENCE TO RELATED APPLICATIONS

The present application claims the benefit of the earlier filed provisional application having Ser. No. 63/025,554 filed on May 15, 2020.

### BACKGROUND

Software documentation is written text embedded inside a source code program that explains how different portions of the source code work. The documentation can include inline comments that describe how a method or application programming interface (API) works, the parameters needed to invoke the method/API, the types of the parameters, and/or the return type of the method. Documentation for a class of an object-oriented programming language may provide a brief overview of what the class does and information on the various methods associated with the class.

Software documentation is beneficial for the maintenance of the program and to transfer knowledge to other developers. The documentation helps new developers to quickly learn the workings of the program. Additionally, the documentation is used for future maintenance of the program. However, at times, the documentation maybe incomplete or outdated which becomes a problem.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A code documentation generator incorporates a neural transformer model with attention to predict the contents of a documentation string for a method in a context that includes a corresponding method signature and optionally, a method body corresponding to the method signature. The documentation string or docstring is natural language text written in a particular style indicating the intended usage of a method (i.e., function, procedure), the method signature, the parameters needed to invoke the method, the types of the parameters, and/or the return value and type of the method.

The neural transformer model with attention is pre-trained with sequences of source code from multiple programming languages and then fine-tuned on supervised translation tasks for the neural transformer model to learn to translate a method signature into a docstring of a particular code documentation style (e.g., reStructuredText, Javadoc style, numpydoc, etc.)

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 illustrates an exemplary code documentation system that predicts a docstring for a method of a particular code documentation style.

FIG. 2 is a schematic diagram illustrating an exemplary architecture of a neural transformer model based on encoder and decoder blocks with attention.

FIG. 3 is a flow diagram illustrating an exemplary method for training the neural transformer model and deploying the neural transformer model in a code completion system.

FIG. 4 is a schematic diagram illustrating an exemplary transfer learning system for training the neural transformer model.

FIG. 5 is flow diagram illustrating an exemplary method for pre-training the neural transformer model.

FIG. 6 is a schematic diagram illustrating an exemplary process for pre-training the neural transformer model and the components used therein.

FIG. 7 is a flow diagram illustrating an exemplary method for fine-tuning the neural transformer model.

FIG. 8 is a schematic diagram illustrating an exemplary process for fine-tuning the neural transformer model and the components used therein.

FIGS. 9A-9B are schematic diagrams illustrating the interference process that uses the neural transformer model.

FIG. 10 illustrates an exemplary code completion system using the neural transformer model.

FIG. 11 is a flow diagram illustrating an exemplary method of a code completion system using the neural transformer model.

FIG. 12 is a flow diagram illustrating an exemplary method of the beam search used in the code completion system.

FIG. 13 is a block diagram illustrating an operating environment.

### DETAILED DESCRIPTION

Overview

The subject matter disclosed pertains to a code documentation generator based on a neural transformer model with attention. Automatic code documentation generation is the task of predicting the contents of a documentation string for a method in the context contained by a corresponding method signature, which is a structured label, and optionally, the method body corresponding to the method signature. The documentation string or docstring is natural language text, such as source code comments, written in a particular style indicating the intended usage of a method (i.e., function, procedure), the method signature, the parameters needed to invoke the method, the types of the parameters, and/or the return value and type of the method.

In one aspect, the code documentation generator may be part of a code completion system that automatically generates documentation as a developer is working on a method in a software development tool. The code documentation generator provides one or more suggested docstrings in the code documentation style of the source code program and which may be embedded directly into the source code.

A code documentation style is a set of guidelines for writing code documentation. This is no universal standard for all programming languages and as such, there are various code documentation styles. A source code program typically uses a particular code documentation style. The code documentation generator suggests a docstring formatted in the code documentation style used in the source code program.

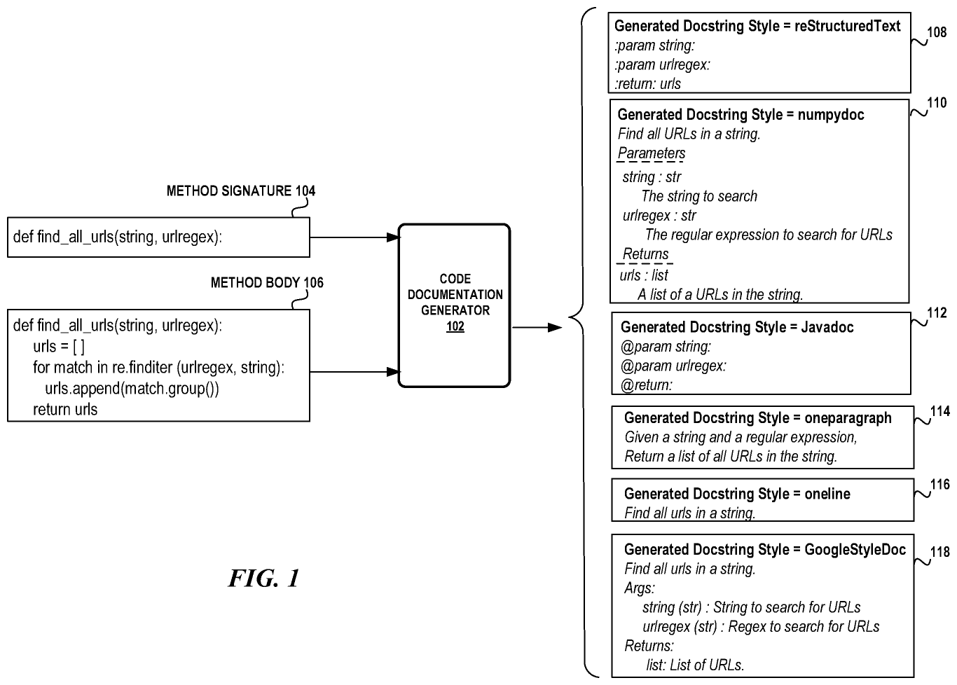

For example, as shown in FIG. 1, the code documentation generator 102 may receive a method signature 104, in the Python programming language, such as def find_all-urls(string, urlsregex): or the combination of the method signature 104 with the corresponding method body 106. The code documentation generator 102 predicts a likely docstring for the method in the documentation style format used in the source code program. FIG. 1 illustrates several docstring candidates 108-118 in different code documentation styles. Each code documentation style differs in the syntax of the docstring and the contents of the docstring.

The reStructuredText is a code documentation style used primarily for source code programs written in the Python programming language. The reStructuredText docstring 108 for a method identifies each parameter variable (:param string, :param urlregx) and return variable (:return urls). The numpydoc docstring style 110 consists of a number of sections separated by headings. For a method, the numpydoc docstring style contains a description of the method, a list of the parameters in a parameter section, and the return values listed in a return section. The JavaDoc style, 112, embeds the docstring in comments that are delimited by an initial comment tag /** and an end comment tag */. For a method, the JavaDoc style uses the at (@) character to identify the parameters (@param string, @param urlregx) and return values of a method (@return).

The one paragraph style, 114, simply describes the method in a single paragraph, such as, Given a string and a regular expression. Return a list of all URLs in the string. The one line style, 116, describes the method in a single line of text, such as, Find all urls in a string.

There are Google Style Guides for each programming language. For the Python programming language, the Google Style Guide recommends that the documentation for a method contains a description of the method, the arguments of the method including their respective data types, and the return value and respective data type. As shown in block 118, the description of the method is Find all urls in a string. The parameters or arguments of the method and their data type are listed as Args: string(str): String to search for URLs, urlregex(str): Regex to search for URLs. The return values are listed as Returns: list: List of URLs.

The code documentation generator 102 is based on a neural transformer model with attention trained on multiple modalities, such as source code and natural language text (e.g., documentation in source code). The neural transformer model handles dependencies between its input and output with attention and without using recurrent neural networks (RNN) (e.g., long short-term memory (LSTM) network) and convolutional neural networks (CNN). Attention is a mechanism that identifies which parts of an input sequence are relevant to each symbol in the output sequence and allows the neural transformer to access the entire input sequence all at once.

The neural transformer model is pre-trained on a large unsupervised training dataset of source code using a span masking objective, wherein the neural transformer model learns the relationships between different source code elements by predicting the original spans of source code that were masked. The pre-trained neural transformer model is then fine-tuned on several translation tasks so the neural transformer model learns to translate a method/method body into a docstring of a particular style.

Attention now turns to a description of the architecture of the neural transformer model.

Neural Transformer Model Architecture

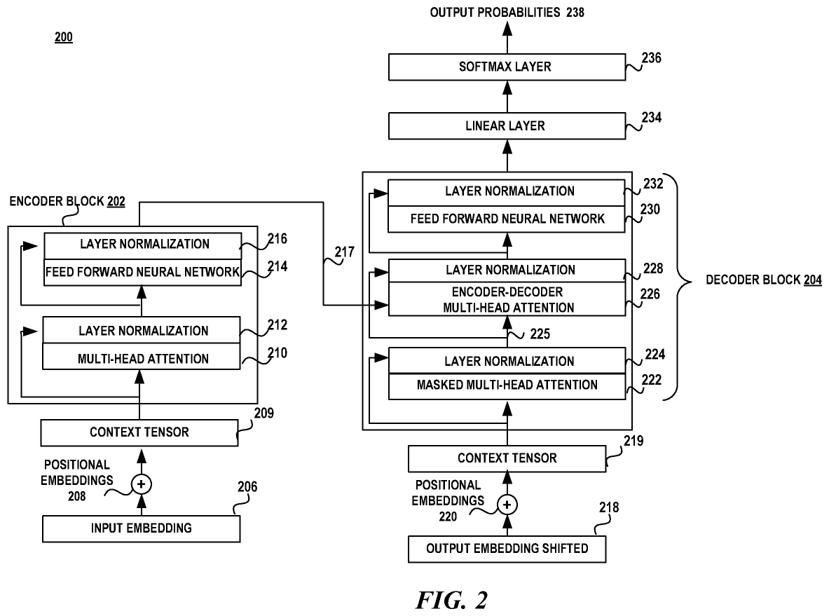

FIG. 2 shows an exemplary structure of the neural transformer model in an encoder-decoder configuration. The neural transformer model 200 contains one or more encoder blocks 202 and one or more decoder blocks 204. The initial inputs to an encoder block 202 are the input embeddings 206 of an input sequence of the training dataset. In order to retain the order of the tokens in the input sequence, positional embeddings 208 are added to the input embedding 206 forming a context tensor 209. The initial inputs to the decoder block 204 are a shifted sequence of the output embeddings 218 from the previous time step to which the positional embeddings 220 are added forming context tensor 219.

An encoder block 202 consists of two layers. The first layer includes a multi-head attention component 210 followed by layer normalization component 212. The second layer includes a feed-forward neural network 214 followed by a layer normalization component 216. The context tensor 209 is input into the multi-head attention layer 210 of the encoder block 202 with a residual connection to layer normalization 212. The output of the layer normalization 212 is input to the feed forward neural network 214 with another residual connection to layer normalization 216. The output of the encoder block 202 is a set of hidden representations 217. The set of hidden representations 217 is then sent through additional encoder blocks, if multiple encoder blocks exist, or to the decoder 204.

Attention is used to decide which parts of the input sequence are important for each subtoken, especially when decoding long sequences since the encoder is limited to encoding a fixed-size vector. Attention mechanisms gather information about the relevant context of a given subtoken and then encode that context into a vector which represents the subtoken. It is used to identity the relationships between subtokens in the long sequence while ignoring other subtokens that do not have much bearing on a given prediction.

The multi-head attention component 210 takes a context tensor 209 and weighs the relevance of each subtoken represented in the context tensor to each other by generating attention weights for each subtoken in the input embedding 206. In one aspect, the attention function is scaled dot-product attention which is described mathematically as follows:

$$Attention ( Q , K , V ) = softmax ( \frac{Q {K}^{T}}{\sqrt{{d}_{k}}} ) V ,$$

where the input consists of queries Q and keys K of dimension dₖ, and values V of dimension dᵥ. Q is a matrix that contains the query or vector representation of one subtoken in a sequence, K is the vector representations of all subtokens in the sequence, and V is the vector representations of all the subtokens in the sequence.

The queries, keys and values are linearly projected h times in parallel with dᵥ output values which are concatenated to a final value:

MultiHead(Q,K,V)=Concat(head₁, . . . ,headₕ)W^{o},

where headᵢ=Attention(QWᵢ^{Q}, KWᵢ^{K}, VWᵢ^{V}),

with parameter matrices Wᵢ^{Q}ϵ [symbol] ^{d}^{_{model}}^{×d}^{ₖ}, Wᵢ^{K}ϵ [symbol] ^{d}^{_{model}}^{×d}^{ₖ}, Wᵢ^{V}ϵ [symbol] ^{d}^{_{model}}^{×d}^{ₖ}, and W^{O}ϵ [symbol] ^{hd}^{ᵥ}^{×d}^{_{model}}.

In order to reduce the training time of the neural transformer, layer normalization is used between the layers. The layer normalization component normalizes the inputs across the features. The mean and standard deviation is computed across the feature dimensions. There is a first layer normalization 212 that precedes the feed forward neural network 214 and a second layer normalization 216 that follows the feed forward neural network 214.

The feed-forward neural network 214 processes each output encoding separately 213. The output of the top encoder block is a set of attention vectors K and V 217 which is used by the encoder-decoder multi-head attention layer 226 of the decoder block 204.

The decoder block 204 predicts each subtoken tᵢ in the target language one-by-one at each time step conditioned on all previously-generated target subtokens t₁, . . . tᵢ₋₁. The decoder block 204 consists of three layers. The first layer includes a masked multi-head attention component 222 followed by a layer normalization component 224. The output of the layer normalization component 224 is input into the encoder-decoder multi-head attention component 226 with a residual connection to layer normalization component 228. The second layer includes an encoder-decoder multi-head attention component 226 followed by a layer normalization component 228. The output of layer normalization component 228 is input into the feed forward neural network 230 with a residual connection to layer normalization component 232. The third layer includes a feed forward neural network 230 followed by a layer normalization component 232.

The masked multi-head attention component 222 receives the output embeddings of the previous timestep. The masked multi-head attention component 222 masks the output embeddings from future time steps. The encoder-decoder multi-head attention layer 226 receives queries from the previous decoder layer 225 and the memory keys and values 217 from the output of the encoder block 202. In this manner, the decoder block 204 can attend to every position of the input sequence. The feed-forward neural network 230 processes each output encoding separately. A layer normalization component 224, 228, 232 is used between the layers in order to normalizes the inputs across the features.

The linear layer 234 projects the vector produced by the stack of decoders into a logits vector. The softmax layer 236 then turns the scores of the logits vector into probabilities for each subtoken in the vocabulary which are positive and normalized.

In one aspect, the neural transformer model contains a stack of six encoder blocks and a stack of six decoder blocks which are aggregated into a neural transformer block. The output of each encoder block is passed onto the next encoder block and processed. Each decoder block receives the attention weights computed from the last encoder block. The use of multiple stacked encoder blocks and decoder blocks increases the model's capacity allowing the model to learn increasing levels of abstraction.

Neural Transformer-Based Code Documentation Generation

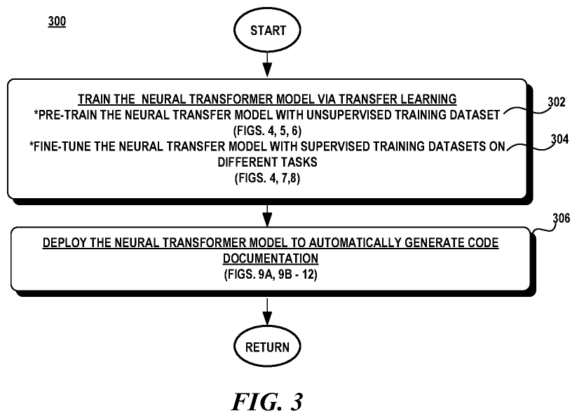

FIG. 3 is a flow diagram illustrating an exemplary process of a neural transformer model-based code completion system 300. Initially, the neural transformer is trained through a transfer learning process that includes pre-training the neural transformer model with an unsupervised training dataset (block 302) and fine-tuning the neural transformer model with a supervised training dataset (block 304). The unsupervised training dataset includes source code and the supervised training data includes both source code and natural language text. When the model has been trained and verified successfully, the model is deployed into a code documentation generation system (block 306).

Transfer Learning

The neural transformer model is trained through transfer learning. Transfer learning is a methodology of training models by pre-training the model using unsupervised learning on unlabeled data to learn generalized knowledge and then fine-tuning the model for sequence-to-sequence translation tasks via supervised learning on labeled data. The neural transformer model is pre-trained on a large unsupervised training dataset of unlabeled source code that contains the method name, method parameters, and method body using a denoising objective and then separately fine-tuned on source code and natural language docstrings on multiple translation tasks.

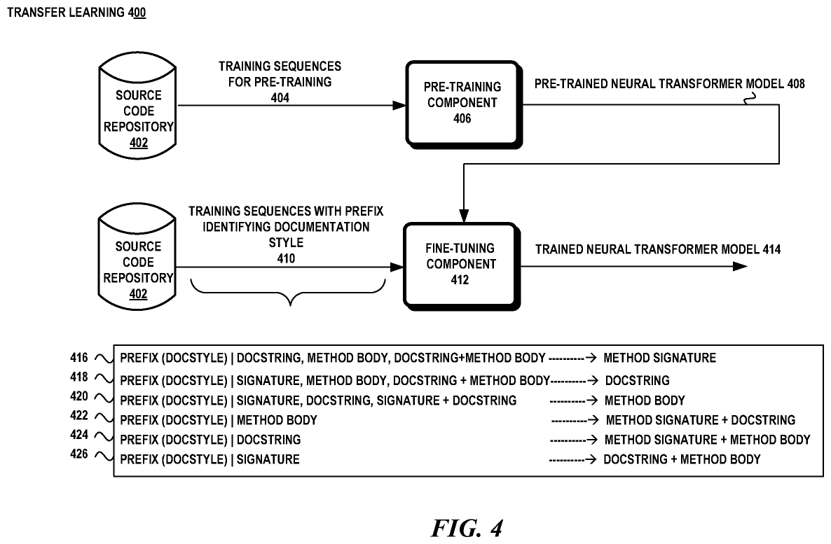

FIG. 4 illustrates the transfer learning system 400. Turning to FIG. 4, a pre-training component 406 generates an unsupervised training dataset 404 from source code files from various source code repositories 402. The pre-training component 406 trains the pre-trained neural transformer model 408 which is then fined tuned by the fine-tuning component 412.

The fine-tuning component 412 model is then trained with a large supervised training dataset of labeled source code and natural language text obtained from various source code files of a source code repository 402. The natural language text includes text strings of descriptions of methods found in the source code referred to herein as document strings (i.e., docstring). The fine-tuning component 412 generates a supervised training dataset 410 to train the pre-trained neural transformer model 408 for specific translation tasks. The supervised training dataset 410 consists of a prefix that identifies the translation task that the model is to learn. There are various translation tasks, such as method signature, document string, method body, method signature and document string, method signature and method body, and document string and method body. The prefix indicates a sequence-to-sequence translation task the model is to associate with the input sequence. For example, a prefix may include “#target document style” which indicates that model is to correlate the input features to a particular code document style.

The training sequence 410 consists of combinations of a method signature, method body and document string which are tailored to generate a particular code documentation style. The combination of a document string, method body, and document string with a method body are used to train a method signature 416. The combination of a signature, method body, and document string with a method body are used to train a document string 418. The combination of a signature, document string, and method signature with a document string are used to train a method body 420. A method body is used to train the combination of a method signature and a method body 422. A document string is used to train the combination of a method signature and method body 424. A method signature is used to train the combination of a document string and a method body 426.

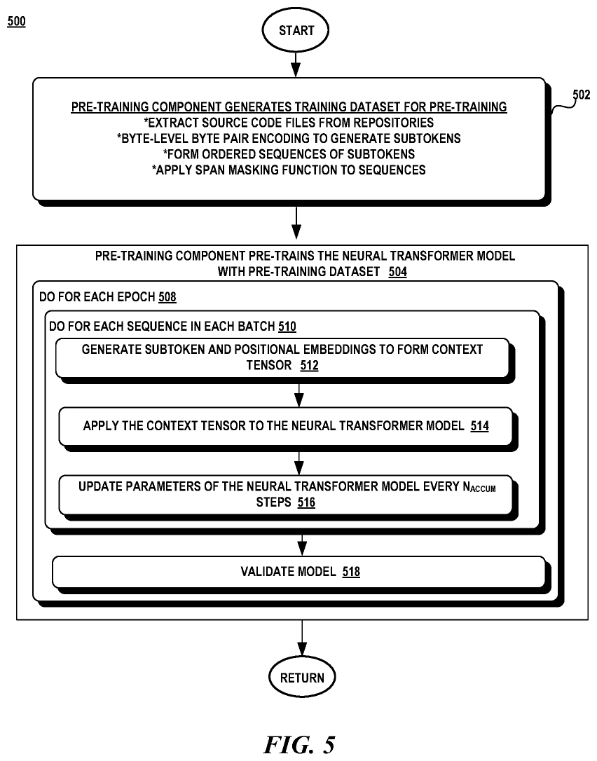

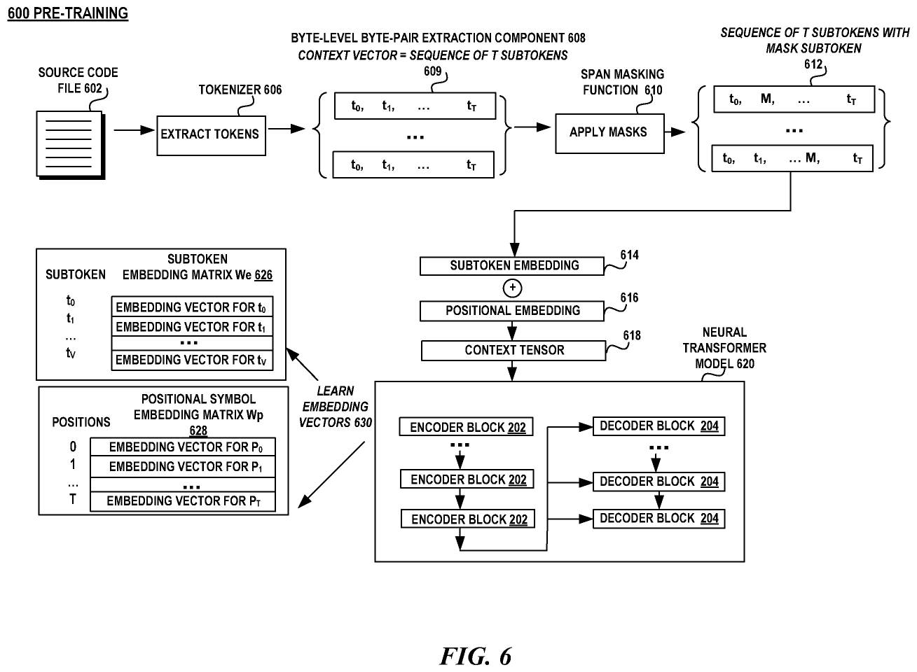

FIGS. 5 and 6 illustrate an exemplary method for pre-training the neural transformer model. Turning to FIGS. 4, 5 and 6, the pre-training training component 406 generates a training dataset to pre-train the neural transformer model 408 (block 502). The pre-training component 406 generates a model pre-trained on a diverse corpus of unlabeled source code programs or files 602. This is referred to as unsupervised learning since the model draws inferences from the input data without labeled responses. The pre-training component 406 extracts selected source code files 602 from various source code repositories 402. The source code files 602 contain context beyond method bodies, method signatures, and docstrings, such as class contexts, namespaces, imports, globals, comments, and scripts.

A source code repository 402 may be a file archive and web hosting facility that stores large amounts of source code either privately or publicly. A source code repository 402 can be structured as a version control system, such as GIT, Mercurial, etc. The source code files residing in the source code repository 402 vary and may be written in different programming languages. The selected source code files 602 can come from different domains, such as without limitation, scientific computing, web development, dataflow programming, machine learning, and the like.

The pre-training component 406 uses a tokenizer 606 to extract tokens from the source code files 602. The frequently-used elements in a programming language are encoded into tokens and the less frequently-occurring elements are encoded into combinations of characters referred to as subtokens. For simplicity, the term subtoken shall include tokens and subtokens.

The pre-training component 406 uses a byte-level byte-pair extraction algorithm 608 to generate T-ordered sequences of subtokens 609, where T is the maximum context length. Byte-level byte-pair encoding (BBPE) is used to generate the vocabulary used by the neural transformer model. A text string, either a sequence of source code or a natural language text, is represented as a sequence of Unicode Transform Format, UTF-8 bytes. The input text string of subtokens is encoded as a sequence of UTF-8 bytes, where a subtoken is encoded into one to four bytes. A byte sequence is then partitioned into byte-level subwords, referred to as byte n-grams. (Collectively, block 502).

The byte-level subwords are generated using the Byte Pair Encoding (BPE) algorithm, which extracts the k most frequently-occurring n-grams. The result is a vocabulary size of the k most frequently-occurring n-grams. An n-gram is a contiguous sequence of n subtokens from an input text string of either source code or natural language text. This type of encoding does not rely on knowing the underlying language making it suitable for an input sequence of text strings that contain source code or natural language text. The ordered sequences of UTF-8 bytes are translated into a T-ordered sequence of subtokens which are vector representations of a source code fragment or natural language text. The T-ordered sequence of subtokens are represented in a context vector 610. (Collectively, block 502).

A denoising function, such as a span masking function 610, is then applied to each sequence that randomly masks out a subset of subtokens and the masked span of subtokens is replaced with a mask subtoken, M. The model is trained with the masked sequences to learn to reconstruct the original sequence without the masked subtokens. In one aspect, the mask subtoken replaces a span of subtokens. The number of text spans and the span lengths are randomly generated and each span is replaced with a single mask subtoken. The masked denoising is based on the doze task of evaluating human language-learners' proficiency, in which humans are given a foreign language with missing words, and are asked to correctly choose the missing word. The benefit of span-masking denoising in pre-training is that the model learns the desired language in an unsupervised fashion, but also is bi-directional in the sense that it learns the relationships of words both before and after their occurrence. (Collectively, block 502).

The pre-training component 406 then pre-trains the neural transformer model with the pre-training dataset. Neural transformer models are trained iteratively, making multiple passes over the training dataset before converging to a minimum. An epoch represents the entire training dataset passed forwards and backwards through the neural transformer block once. Since the training dataset is very large, it is partitioned into smaller batches. The training is iterative and the entire dataset is passed through the neural transformer in multiple iterations. Each training iteration includes forward propagation, loss calculation, backpropagation steps followed by updating the weights. The training dataset is partitioned into batches with each batch of sequences running through the training process. (Collectively, block 504).

The neural transformer model has multiple blocks and layers so that more detailed relationships within the data are learned as well as how the features interact with each other on a non-linear level. The model architecture, training procedure, data normalization and vocabulary encoding procedures are hyperparameters that are tailored to meet a particular objective. The values of the hyperparameters influence how the parameters are learned. (Collectively, block 504).

In one aspect, the hyperparameters may include the following: (1) subtoken and position embedding layers of dimensions: 30000×768, and 1024×768 respectively; (2) the configuration of the neural transformer model with six encoder blocks and six decoder blocks; (3) for the training procedure: denoising auto-encoder, with a cross-entropy loss optimization objective; the sequence length of 1024 symbols; a mini-batch size of 8; the gradient accumulation steps for each weight update is 8; the Adam stochastic optimization procedure is used to train the feed forward neural network; and the learning rate is 0.0001; (4) the data normalization procedure: normalize all string and numerical literals, keeping the ten most frequent; and (5) the vocabulary encoding procedure: byte-level byte-pair encoding, preserve the ten most frequent string and numerical literals encoding them as a single token during byte-level byte-pair encoding procedure; and introduce special control flow tokens to denote end-of-line, end-of-file, end-of-method, end-of docstring, dedent, and indent symbols. (Collectively, block 504).

For each sequence of each batch in each epoch (blocks 508, 510), the T-ordered sequences of subtokens are then mapped into numeric vectors and then into respective subtoken embeddings 614 and positional embeddings 616 (block 512). An embedding is a learned representation for the text-based subtokens where subtokens that have a common meaning have a common representation. An embedding is a mapping of discrete categorical variables to a vector of continuous numbers. There is an embedding for each subtoken in the vocabulary 614 and a corresponding positional embedding 616. The subtoken embedding 614 represents the learned representation for the subtoken. The neural transformer model does not read each subtoken sequentially and as such, has no knowledge of the subtoken's position in a sequence without additional position information. The positional embedding 616 is used to encode position information about a subtoken's position in a sequence into the neural transformer model 620.

Initial values are generated for the subtoken embedding and positional embeddings of each sequence which are then used to form a context tensor 618. Thereafter, the neural transformer model 620 learns the values for each embedding. Upon the completion of the training phase, the embeddings for each subtoken and the positional embeddings are saved into respective matrices for later use. There is a subtoken embedding matrix, We, 626 that contains an embedding vector for each subtoken tᵢ, i=0 . . . V, and a positional embedding matrix, Wp, 628 that contains an embedding vector Pⱼ, j=0 . . . T, for each position, where V is the size of the vocabulary and T is the length of the subtoken sequence. (Collectively, block 512).

The first encoder block 202 of the neural transformer model 620 takes the context tensor 618 as input and passes it through the multiple layers of multi-head attention, layer normalization and feed-forward neural network to finally produce a a set of hidden representations If there are additional encoder blocks, the output of each encoder block is passed onto the next encoder block with the output of the last encoder block producing the set of hidden representations. The set of hidden representations is passed onto each decoder block. (Collectively, block 514).

The decoder blocks 204 of the neural transformer model 620 takes a shifted sequence of an output embedding as input. The masking in the masked multi-head attention layer is used to prevent positions from attending to subsequent positions in the future. The masking combined with the output embeddings shifted by one position ensures that the predictions to position T depend only on the known outputs at positions less than T. Starting with the first token of the output sequence, the subtokens are passed through the self-attention and normalization layers and into the encoder-decoder attention layer, serving as the query for encoder-decoder attention, where the key and value pairs for the attention are the outputs of encoder. The encoder output was calculated with the entire input embedding sequence. (Collectively, block 514).

The feed forward neural networks in the encoder blocks 202 and the decoder blocks 204 are trained iteratively, making multiple passes over the training dataset before converging to a minimum. Each training iteration includes forward propagation, loss calculation, backpropagation steps followed by updating the weights by calculating the weight gradients. The loss function estimates the loss or error which is used to compare how good or bad the predicted results are. In one aspect, a categorical cross-entropy loss function is used. Once the loss is calculated, it is propagated backwards to the hidden layer that contributed directly to the output. In backpropagation, the partial derivatives of the loss function with respect to the trainable parameters are determined. The weight gradients are calculated as the difference between the old values and the new values of the weights. The weights are adjusted to make the loss as small as possible using a gradient descent technique. In one aspect, a Stochastic Gradient Descent (SGD) method is the optimization algorithm used to find the values of parameters of the function that minimizes the loss function. A backpropagation through time (BPTT) algorithm may be used to update the weights. (Collectively, block 514).

At the completion of each batch, the parameters of the neural transformer model are updated at a preconfigured frequency denoted as Naccum. Naccum is a gradient accumulation frequency and in one aspect has a value of 8. The parameters include the subtoken embeddings and the positional embeddings which are stored in a respective embedding matrix. (Collectively, block 516).

Next, the neural transformer model is validated. Before the neural transformer model is trained, a set of hyperparameters is selected randomly and then tuned to achieve a desired performance. The neural transformer model is tested using a validation dataset to determine the appropriate hyperparameters settings to achieve a desired goal. When the desired goal is not achieved, one or more hyperparameters are adjusted and the training is repeated until the target goal is achieved. Perplexity on the validation set is calculated to validate the performance of the model with respect to the learning the masked out original text. (Collectively, block 518).

Fine-Tuning Training

After the pre-training is performed, the neural transformer model is fine-tuned on individual supervised tasks. The fine-tuning ensures that the neural transformer model understands the relationship between a method signature, a method body, and a document string that corresponds to the method by training the model with different combinations of these features. The repetition of the features in different combinations improves the model's ability to learn the relationships between the different features. A prefix is prepended to the context vector to instruct the neural transformer model which task it is to target.

The pre-trained model is fine-tuned on the translation tasks. Specifically, the optimization objective during fine tuning includes method body prediction given the method signature, or the method signature and the natural language text as an input. The weights of the pre-trained model are transferred and joined to optimize all of the trainable parameters—including both the transformer layers and the task-specific head of the model.

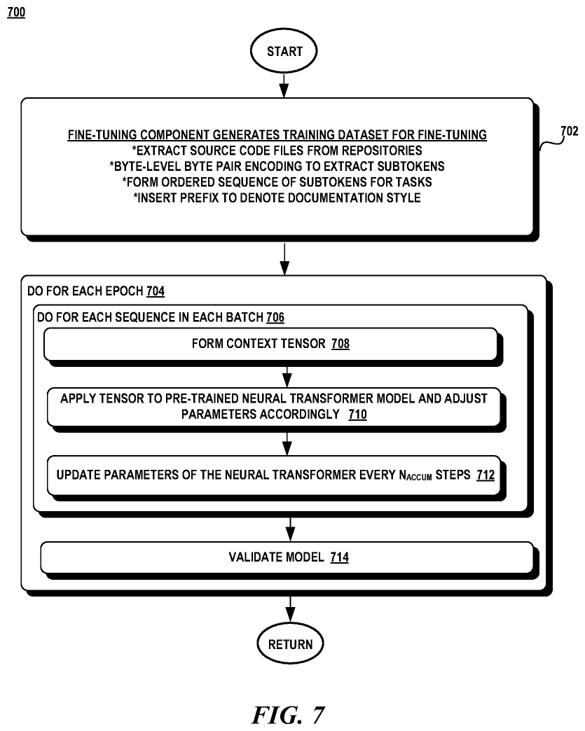

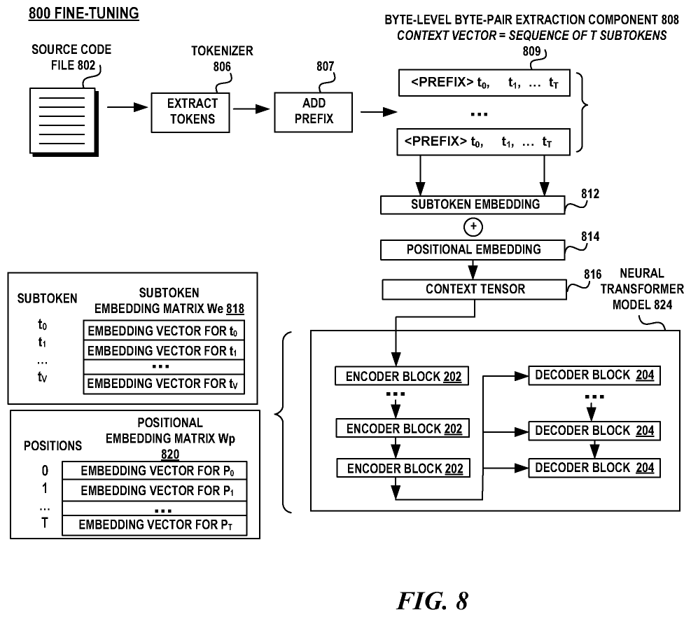

Turning to FIGS. 4, 7, and 8, the fine-tuning component 412 generates training datasets from a source code repository containing various combinations of method signatures, method bodies and corresponding document strings. In particular as shown in FIG. 4, the training sequences 416-426 contain various combinations of features that are used in the training dataset with a prefix prepended to the sequence indicating the target task. For example, the combination of a docstring, method body, and docstring and method body have a prefix indicating a method signature 416. The prefix acts as an imperative which the model learns to interpret since the model is always shown the prefix informing the model about the target translation task. Therefore, the neural transformer model learns to associate the prefix with the type of intended translation target.

The fine-tuning training 800 follows a similar method noted above with respect to the pre-training. Initially, the fine-tuning component 412 generates a fine-tuning dataset from source code files 802 obtained from a source code repository 402. A tokenizer 806 is used to extract an ordered sequence of tokens. The tokens are then converted into a byte-level byte pair encoded representation using a byte-level byte-pair extraction component 808 and then into an ordered sequence of subtokens 809. The sequence 809 is prepended with a prefix 807 indicating the target representation. (Collectively, block 702).

A subtoken embedding 812 and positional embedding 814 is generated for each sequence of each batch of each epoch. The subtoken embedding 812 and the positional embedding 814 are combined into a context tensor 816 (blocks 704, 706, 708). The context tensor 816 is applied to the neural transformer model, as noted above, and updating the subtoken and positional embedding matrices 818, 820 (block 710).

The parameters are updated for every Naccum steps (block 712). The neural transformer model is then validated before deployed into a code completion system (block 714).

Attention now turns to discussion of the use of the neural transformer model in an inference system.

Inference Phase

The inference phase of the code completion system relies on a beam search to generate one or more document strings corresponding to a method signature and/or method body. The decoder's computation at training time can be parallelized using masked self-attention but during inference, the subtokens are generated one token at a time. The neural transformer model factorizes the probability of the target subtokens in an input sequence into a product of conditional probabilities for each subtoken using the formula: p(t₁, . . . tₘ|s)=Πᵢ₌₁^{m} p(tᵢ|t₁, . . . , tᵢ₋₁, s). During inference, the calculation of arg maxₜ p(t|s) is complex and extremely time consuming. Beam search is an approximation algorithm that performs faster.

The beam search uses the probability distribution generated by the neural transformer model to identify the top k subtokens likely to be the next subtoken in a candidate sequence. The beam search expands the search by instantiating new partial sequences using each of the selected subtokens identified by the neural transformer model's probability distribution. The search continues generating new partial sequences from the top k subtokens identified by the output distributions from the neural transformer model until the search ends. The search may end when the end-of-docstring subtoken appears as the most probable next subtoken.

A beam search uses a breadth-first search to build a search tree. The search tree is composed of nodes at one or more inference levels. Each node represents a probability distribution generated by the neural transformer model for the subtokens in the model vocabulary. At each level, only the top k subtokens having the highest probabilities from the output distribution generated by the neural transformer model are expanded to the next inference level. The variable k is preconfigured and referred to as the beam width. Each of the k subtokens is then expanded into a search that updates the current context sequence with the selected subtoken to input into the neural transformer model to generate an additional probability distribution for the next subtoken in a sequence. This process is repeated until the end of a method token is predicted as being the next likely subtoken candidate.

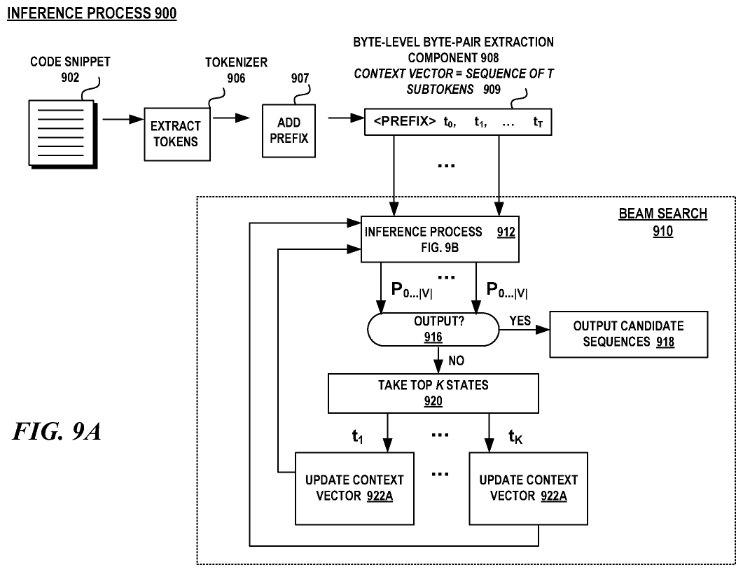

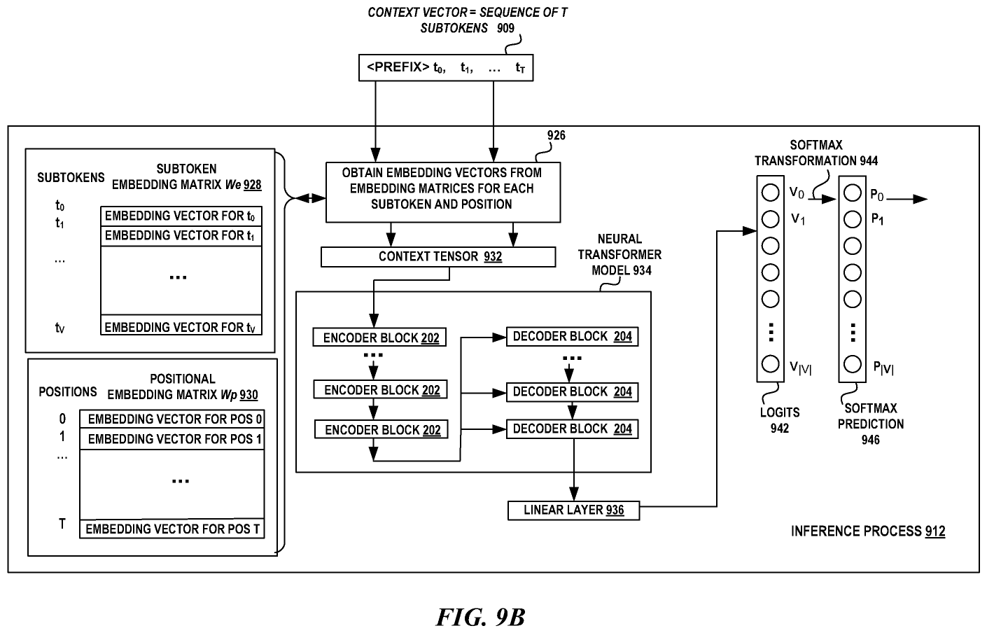

Turning to FIG. 9A, there is shown components of the inference phase 900. A code snippet 902 is entered into a source code editor which is transformed into a corresponding concrete syntax tree 904. The code snippet may be a method signature or the combination of a method signature and a method body. A tokenizer 906 extracts tokens and/or subtokens in an ordered sequence. A prefix 907 is added to the ordered sequences at the beginning of the sequence to indicate the target of the translation. The ordered sequence of T subtokens is then vectorized into a context vector 909 using the subtoken and positional embedding matrices.

The beam search 910 uses the context vector 909 to initiate an inference process 912 using the probability distribution generated from the neural transformer model, P₀ . . . P_{|V|} (block 912). If the probability distribution indicates that an end-of-document string token is the most likely subtoken to follow in a partial candidate sequence (block 916-yes), then the top k candidate sequences are output (block 918). Otherwise, the beam search 910 takes the top k states or subtokens identified from the probability distribution generated by the neural transformer model in the inference process (block 920). A new context vector is generated for each of the k states, c₁, . . . cₖ, using the new subtoken in the context vector (blocks 922A, 922B). The new context vectors are then input into the inference process (blocks 922A, 922B, 912). The beam search 910 ends when the end-of-document string token is selected as the most likely candidate to complete a partial candidate sequence.

FIG. 9B illustrates an exemplary inference process 912. An embedding vector for each subtoken in a sequence 908 is obtained from the subtoken embedding matrix 928 and its corresponding positional vector from the positional embedding matrix 930. The subtoken embedding vector and its corresponding positional embedding vector are combined to form a context tensor 932 which is input into the neural transformer model 934. The prefix is treated as yet another tokenized feature sequence.

The last decoder block outputs a vector of floating point numbers that is projected by the linear layer 936 into unnormalized predictions or logits V0 . . . V|V| 942. The logits 942 are normalized using the softmax function 944 to generate the softmax prediction 946 P0 . . . P|V|.

Code Completion

Code documentation completion is the task of predicting the contents of a document string in the context contained by a method signature, which is a structured label, and optionally, the method body. One application of code documentation completion is in a code completion system. A code completion system is a tool that attempts to predict the next string of characters that a developer (e.g., user, end-user, programmer, etc.) may type into a source code development tool, such as a source code editor. Source code may consist of various elements (e.g., keywords, delimiters, variables, methods, constants, operators, etc.) that are combined in a particular order in accordance with the grammar of the underlying programming language to form an expression that is used in a program statement. A method signature contains a method name and optionally a parameter list. The method body contains the source code programming language statements that implement the method. A document string is a string associated with the method which is a natural language statement expressing the intent of the method, and sometimes a description of the input, outputs, or idiosyncratic behavior contained therein.

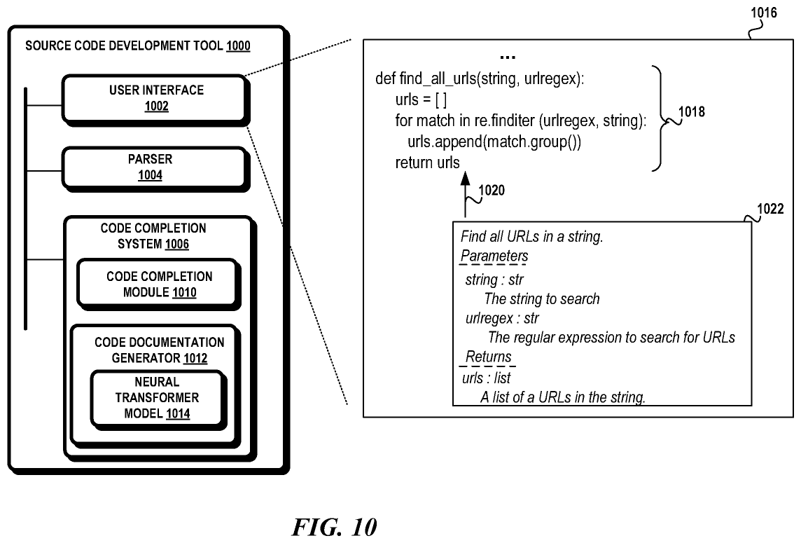

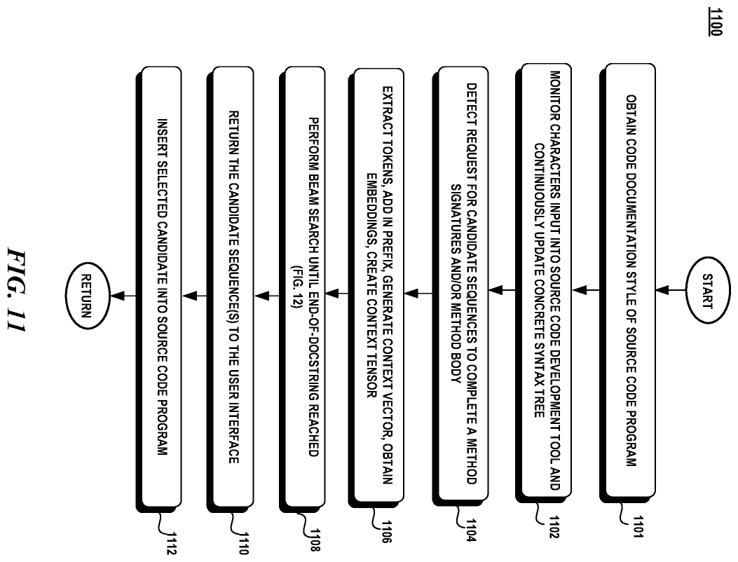

In one aspect, the neural transformer model is used in a code completion system. Referring to FIGS. 10 and 11, the inference phase of the neural transformer model may be embodied as a function or feature integrated into a source code development tool 1000, such as source code editor, integrated development environment (IDE), browser, and/or stand-alone application. Code completion may be embodied as a tool or feature that can be an add-on, plug-in, extension and/or component of a source code editor, browser, application, and/or IDE. In one aspect, a source code development tool 1000 may include a user interface 1002, a parser 1004, and a code completion system 1006. The code completion system 1006 includes a code completion module 1010 and a code documentation generator 1012 having the neural transformer model 1014.

The user interface 1002 includes a set of features or functions for developing (e.g., writing, editing, testing) a source code program. The user interface 1002 may include a window 1016 that displays the source code currently in the source code development tool 1000. The user interface may utilize a pop-up window 1022 to present candidate docstrings for completion thereby allowing a developer to browse through the candidates and to select one from the list. Alternatively, the candidate may appear as a continuation of the current source code program.

Initially, the code documentation generator 1012 obtains the code documentation style of the source code program. In one aspect, the code documentation style may be obtained from the user or developer or the source code development tool (block 1101). As the developer is typing into the source code development tool, the parser 1004 monitors characters input into the source code development tool and generates a corresponding concrete syntax tree. The parser 1004 also updates the concrete syntax tree as the developer creates and edits the source code in the source code development tool. (Collectively, block 1102).

At certain points in the editing process, the user interface 1002 will request candidate docstrings from the code completion system 1006 for a method signature or method signature/method body (block 1104). The user interface 1002 may detect that the user has entered a particular character or a string of characters forming a method signature or method signature/method body and automatically initiate a request for candidate docstrings for the method. This character is referred to as a marker character. In one aspect, the marker character may be the colon “:” which in the Python programming language denotes the end of a method signature statement or the end-of-method character 1020 indicating the end of a method body.

The code completion module 1010 extracts subtokens from the concrete syntax tree, generates a context vector representing a sequence of subtokens, adds in the appropriate prefix, obtains embeddings for the subtokens and creates a context tensor as noted above (block 1106). The code completion module 1010 performs a beam search until an end-of-docstring subtoken is reached (block 1108). The top k candidate docstrings are returned to the user interface 1002 (block 1110).

The user interface 1002 may display the recommended docstring candidates in a pop-up window 1016 in the user interface 1002 or alternatively display a single top candidate inserted into the current source code program. The code completion module 1010 builds and continuously updates a tree of candidates in the background regardless of whether the developer decides to trigger the candidate docstring or not. A light bulb symbol may be automatically displayed in the user interface when the user has typed in a method signature or a method signature and method body and the system has valid completion suggestions. If the developer wants to accept the candidate docstring, the developer may type in a particular keystroke or combination of keystrokes to accept the candidate docstring which is then automatically inserted into the source code program (block 1112).

In this case, the cursor position will advance to the end of the suggested docstring and the suggested docstring will automatically be inserted into the source code program. If the user does not want to use the candidate docstring, the candidate docstring disappears when the developer continues typing. In this case, the system would refine the code sequence based on the pre-fix filter of the tree of candidates based on the newly typed code.

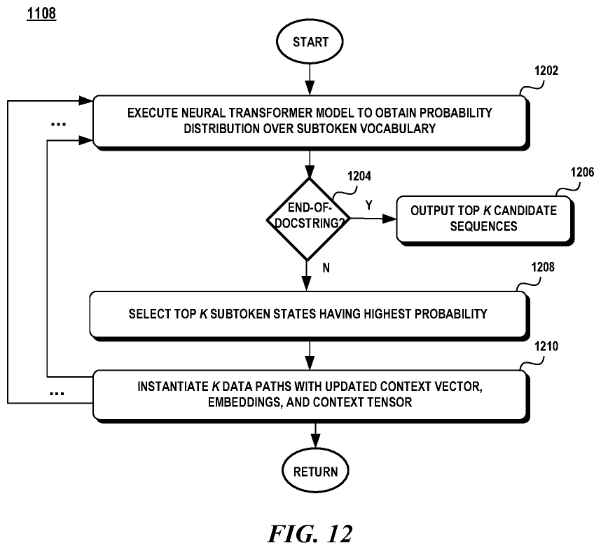

Turning to FIG. 12, the beam search uses the neural transformer model with the context tensor to generate a probability distribution for the subtoken vocabulary (block 1202). If the probability distribution indicates that the next likely token is the end-of-docstring token, then the beam search is finished (block 1204-yes) and the top k candidate sequences are returned to the user interface (block 1206). Otherwise (block 1204-no), the top k subtokens to complete a partial sequence are selected (block 1208).

Each of the selected subtokens is then input in a respective context vector and has a separate data path through the neural transformer model again. The context vector utilizes the selected subtoken in the current context vector with the last subtoken removed. The new context vector will consist of T subtokens with the selected subtoken tₖ added to the beginning of the sequence with the last subtoken removed from the sequence. If the current context vector consists of a subtoken sequence consisting of t₀, t₁, . . . , t_{T}, then the new context vector will consist of tk, t₀, t₁, . . . , t_{T-1}. (Collectively, block 1210).

Exemplary Operating Environment

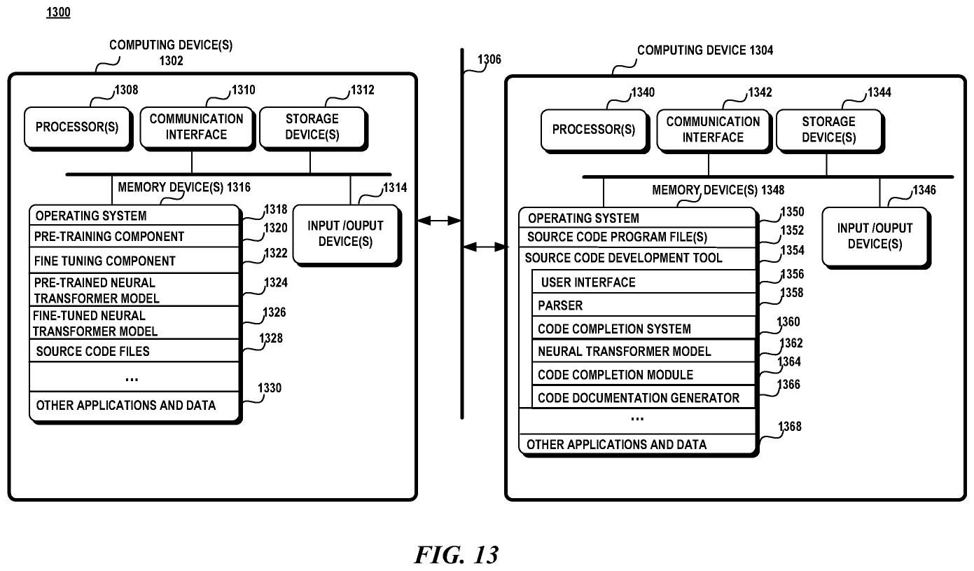

Attention now turns to a discussion of an exemplary operating environment. FIG. 13 illustrates an exemplary operating environment 1300 in which one or more computing devices 1302 are used to train the neural transformer model and a second computing device 1304 uses the neural transformer model for code completion. However, it should be noted that the aspects disclosed herein is not constrained to any particular configuration of devices. Any one of the computing devices 1302, 1304 may utilize the neural transformer model in its own code completion system and computing device 1304 may generate and test the neural transformer model as well. Computing devices 1302 may be configured as a cloud service that generates the neural transformer model as a service for other code completion systems. It should be noted that the operating environment is not limited to any particular configuration and other configurations are possible.

The computing devices 1302, 1304 may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, a distributed computing system, multiprocessor systems, or combination thereof. The operating environment 1300 may be configured in a network environment, a distributed environment, a multi-processor environment, or a stand-alone computing device having access to remote or local storage devices.

The computing devices 1302, 1304 may include one or more processors 1308, 1340, one or more communication interfaces 1310, 1342, one or more storage devices 1312, 1344, one or more input/output devices 1314, 1346, and one or more memory devices 1316, 1348. A processor 1308, 1340 may be any commercially available or customized processor and may include dual microprocessors and multi-processor architectures. A communication interface 1310, 1342 facilitates wired or wireless communications between the computing device 1302, 1304 and other devices. A storage device 1312, 1344 may be computer-readable medium that does not contain propagating signals, such as modulated data signals transmitted through a carrier wave. Examples of a storage device 1312, 1344 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 1312, 1344 in the computing devices 1302, 1304. The input/output devices 1314, 1346 may include a keyboard, mouse, pen, voice input device, touch input device, display, speakers, printers, etc., and any combination thereof.

A memory device 1316, 1348 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. that does not pertain to propagated signals, such as modulated data signals transmitted through a carrier wave. A memory 1316, 1348 may also include one or more external storage devices or remotely located storage devices that do not pertain to propagated signals, such as modulated data signals transmitted through a carrier wave.

Computing device 1304 may utilize a source code development tool 1354 that allows a user (e.g., developer, programmer, designer, coder, etc.) to design, code, compile, test, run, edit, debug or build a program, set of programs, web sites, web applications, and web services in a computer system. Software programs can include source code files, created in one or more source code languages (e.g., Visual Basic, Visual J #, C++. C #, J #, Java Script, APL, COBOL, Pascal, Eiffel, Haskell, ML, Oberon, Perl, Python, Scheme, Smalltalk and the like). The source code development tool 1354 may provide a native code development environment or may provide a managed code development that runs on a virtual machine or may provide a combination thereof. The source code development tool 1354 may provide a managed code development environment using the .NET framework. It should be noted that this operating embodiment is not constrained to providing the source code development services through any particular source code development tools and that other tools may be utilized instead, such as a stand-alone source code editor, IDE, browser and the like.

The memory device 1348 of computing device 1304 may contain instructions, components, and data. A component is a software program that performs a specific function and is otherwise known as a module, program, component, and/or application. The memory device 1348 may include an operating system 1350, one or more source code program files 1352, a source code development tool 1354 that may include a user interface 1356, a parser 1358, a code completion system 1360, a neural transformer model 1362, a code completion module 1364, an code documentation generator 1366, and other applications and data 1368.

The memory device 1316 of computing device 1302 may include an operating system 1318, a pre-training component 1320, a fine-tuning component 1322, a pre-trained neural transformer model 1324, a fine-tuned neural transformer model 1326, source code files 1328 and other applications and data 1330.

The computing devices 1302, 1304 may be communicatively coupled via a network 1306. The network 1306 may be configured as an ad hoc network, an intranet, an extranet, a virtual private network (VPN), a local area network (LAN), a wireless LAN (WLAN), a wide area network (WAN), a wireless WAN (WWAN), a metropolitan network (MAN), the Internet, a portions of the Public Switched Telephone Network (PSTN), plain old telephone service (POTS) network, a wireless network, a WiFi® network, or any other type of network or combination of networks.

The network 1306 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

### CONCLUSION

A system is disclosed having one or more processors and a memory. The memory stores one or more programs that are configured to be executed by the one or more processors. The one or more programs include instructions that: obtain a code documentation style of a source code program; generate code documentation in the code documentation style for a method of the source code program from a neural transformer model with attention based on a method signature of the method; and present the code documentation for use in the source code program.

In one aspect, the one or more programs include further instructions that: obtain the method body of the method; and wherein the neural transformer model generates the code documentation based on the method signature and a method body corresponding to the method signature. The one or more programs may include further instructions that: pre-train the neural transformer model with an unsupervised training dataset, the unsupervised training dataset including a method signature, a method body, and code documentation.

In one or more aspects, the one or more programs include further instructions that: fine-tune the pre-trained neural transformer model with a supervised training dataset, the supervised training dataset containing translation tasks in which the pre-trained neural transformer model learns to translate an input sequence with a code documentation style into an output sequence. In an aspect, the output sequence is a method signature, method body or code documentation. In an aspect, the neural transformer model includes one or more encoder blocks and one or more decoder blocks, wherein an encoder block contains a multi-head attention layer and a feed-forward neural network, wherein a decoder block contains a masked multi-head attention layer, an encoder-decoder multi-head attention layer, and a feed-forward neural network.

A method is disclosed comprising: pre-training a neural transformer model with an unsupervised training dataset, the unsupervised training dataset including a plurality of sequences of source code; fine-tuning the neural transformer model with a supervised multi-modal training dataset, the supervised multi-modal training dataset based on features and a translation task, the features extracted from source code and natural language text, the translation task representing a code documentation style; and applying the neural transformer model to generate a code documentation string for the method in a select code documentation style.

In one aspect, the method further comprises: applying the neural transformer model to generate the code documentation string given a method signature. In an aspect, the method further comprises: applying the neural transformer model to generate the code documentation string given a method signature and a corresponding method body. A sequence of source code may include a plurality of subtokens, a subtoken represented as a byte-level byte-pair encoding. In an aspect, the method further comprises applying a span masking function to the sequence of source code to mask out a subset of subtokens; and wherein the neural transformer model learns original subset of subtokens. In an aspect, the translation tasks include a method signature, a method docstring, a method signature and a method docstring, a method signature and a method body, or a method body and a method docstring. In one aspect, the unsupervised multi-modal training dataset includes source code programs from multiple programming languages. In one or more aspects, the neural transformer model includes one or more encoder blocks and one or more decoder blocks, wherein an encoder block contains a multi-head attention layer and a feed-forward neural network, wherein a decoder block contains a masked multi-head attention layer, an encoder-decoder multi-head attention layer, and a feed-forward neural network. In an aspect, the method further comprises deploying the neural transformer model in a code completion system to generate a docstring for a method.

A device is disclosed comprising at least one processor and a memory. The at least one processor is configured to: train a neural transformer model with attention to learn to translate a method signature into a docstring of a particular code documentation style by transfer learning, wherein the transfer learning pre-trains the neural transformer model from a plurality of unsupervised training data, the plurality of unsupervised training data including method bodies and method signatures derived from source code programs, wherein the transfer learning fine-tunes the neural transformer model using a plurality of translation tasks from a plurality of supervised training data, wherein the neural transformer model learns to translate a method signature into a docstring in a specific code documentation style; and deploy the neural transformer model to predict a code documentations string for a specific method signature in a particular code documentation style.

In one aspect, the plurality of translation tasks includes a method body, a method signature, a method docstring and combinations of a method body, method signature, and/or method docstring. In an aspect, the at least one processor is further configured to: apply a denoising function, in the pre-training, to mask out spans of data in the unsupervised training data for the neural transformer model to learn original spans of data that were masked. In an aspect, the supervised training data includes a prefix indicating a particular code documentation style of a translation task. In one or more aspects, the neural transformer model includes one or more encoder blocks and one or more decoder blocks, wherein an encoder block contains a multi-head attention layer and a feed-forward neural network, wherein a decoder block contains a masked multi-head attention layer, an encoder-decoder multi-head attention layer, and a feed-forward neural network.

It may be appreciated that the representative methods described herein do not necessarily have to be executed in the order presented, or in any particular order, unless otherwise indicated. Moreover, various activities described with respect to the methods can be executed in serial or parallel fashion, or any combination of serial and parallel operations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A system comprising:
one or more processors; and
a memory that stores one or more programs that are configured to be executed by the one or more processors, the one or more programs including instructions that:
obtain a code documentation style of a source code program;
generate code documentation in the code documentation style for a method of the source code program from a neural transformer model with attention based on a method signature of the method; and
present the code documentation for use in the source code program.

2. The system of claim 1, wherein the one or more programs include further instructions that:
obtain the method body of the method; and
wherein the neural transformer model generates the code documentation based on the method signature and a method body corresponding to the method signature.

3. The system of claim 1, wherein the one or more programs include further instructions that:
pre-train the neural transformer model with an unsupervised training dataset, the unsupervised training dataset including a method signature, a method body, and code documentation.

4. The system of claim 3, wherein the one or more programs include further instructions that:
fine-tune the pre-trained neural transformer model with a supervised training dataset, the supervised training dataset containing translation tasks in which the pre-trained neural transformer model learns to translate an input sequence with a code documentation style into an output sequence.

5. The system of claim 4, wherein the output sequence is a method signature, method body or code documentation.

6. The system of claim 1, wherein the neural transformer model includes one or more encoder blocks and one or more decoder blocks, wherein an encoder block contains a multi-head attention layer and a feed-forward neural network, wherein a decoder block contains a masked multi-head attention layer, an encoder-decoder multi-head attention layer, and a feed-forward neural network.

7. A method, comprising:
pre-training a neural transformer model with an unsupervised training dataset, the unsupervised training dataset including a plurality of sequences of source code;
fine-tuning the neural transformer model with a supervised multi-modal training dataset, the supervised multi-modal training dataset based on features and a translation task, the features extracted from source code and natural language text, the translation task representing a code documentation style; and
applying the neural transformer model to generate a code documentation string for the method in a select code documentation style.

8. The method of claim 7, further comprising:
applying the neural transformer model to generate the code documentation string given a method signature.

9. The method of claim 7, further comprising:
applying the neural transformer model to generate the code documentation string given a method signature and a corresponding method body.

10. The method of claim 7, wherein a sequence of source code includes a plurality of subtokens, a subtoken represented as a byte-level byte-pair encoding.

11. The method of claim 9, further comprising:
applying a span masking function to the sequence of source code to mask out a subset of subtokens; and
wherein the neural transformer model learns original subset of subtokens.

12. The method of claim 7, wherein the translation tasks include a method signature, a method docstring, a method signature and a method docstring, a method signature and a method body, or a method body and a method docstring.

13. The method of claim 7, wherein the unsupervised multi-modal training dataset includes source code programs from multiple programming languages.

14. The method of claim 7, wherein the neural transformer model includes one or more encoder blocks and one or more decoder blocks, wherein an encoder block contains a multi-head attention layer and a feed-forward neural network, wherein a decoder block contains a masked multi-head attention layer, an encoder-decoder multi-head attention layer, and a feed-forward neural network.

15. The method of claim 7, further comprising:
deploying the neural transformer model in a code completion system to generate a docstring for a method.

16. A device, comprising:
at least one processor and a memory;
wherein the at least one processor is configured to:
train a neural transformer model with attention to learn to translate a method signature into a docstring of a particular code documentation style by transfer learning,
wherein the transfer learning pre-trains the neural transformer model from a plurality of unsupervised training data, the plurality of unsupervised training data including method bodies and method signatures derived from source code programs,
wherein the transfer learning fine-tunes the neural transformer model using a plurality of translation tasks from a plurality of supervised training data, wherein the neural transformer model learns to translate a method signature into a docstring in a specific code documentation style; and
deploy the neural transformer model to predict a code documentations string for a specific method signature in a particular code documentation style.

17. The device of claim 16, wherein the plurality of translation tasks includes a method body, a method signature, a method docstring and combinations of a method body, method signature, and/or method docstring.

18. The device of claim 16, wherein the at least one processor is further configured to:
apply a denoising function, in the pre-training, to mask out spans of data in the unsupervised training data for the neural transformer model to learn original spans of data that were masked.

19. The device of claim 16, wherein the supervised training data includes a prefix indicating a particular code documentation style of a translation task.

20. The device of claim 16, wherein the neural transformer model includes one or more encoder blocks and one or more decoder blocks, wherein an encoder block contains a multi-head attention layer and a feed-forward neural network, wherein a decoder block contains a masked multi-head attention layer, an encoder-decoder multi-head attention layer, and a feed-forward neural network.
